(19) United States
(12) Patent Application Publication
(10) Pub. No.: US 2012/0031267 A1
(43) Pub. Date: Feb. 9, 2012

(54) Method to cool compressor recycle gas in cyclic adsorption processes

(75) Inventors: APURVA MAHESHWARY, Edison, NJ (US); John R. Ambriano, Hockessin, DE (US); James J. Flaherty, Hampton, NJ (US); Krishamurti V. Subramanian, Bridgewater, NJ (US)

(73) Assignee: ADSORPTECH INC., MIDDLESEX, NJ (US)

(21) Appl. No.: 12/852,616

(22) Filed: Aug. 9, 2010

(51) Int. Cl. B01D 53/047

(52) U.S. Cl. 95/41

(57) ABSTRACT

The present invention provides for a method to cool the recycle gas in a product compressor being used with a cyclic adsorption process. It simplifies the scheme by eliminating need to provide a separate cooler for recycle gas.

### FIELD OF THE INVENTION

The present invention provides for a method to cool auxiliary compressor recycle gas in a vacuum pressure swing adsorption process (VPSA) or a pressure swing adsorption process (PSA). The method can eliminate or reduce the need for an after-cooler at the compressor discharge.

### BACKGROUND OF THE INVENTION

Cyclic adsorption processes are frequently used to separate the components of a gas mixture. Typically, cyclic adsorption processes produce the desired product during a certain portion of the total cycle. In order to maintain continuous flow these processes require a product receiver often called a buffer tank. The buffer tank usually fluctuates in pressure depending upon the flow of gas and its size. In many cases the gas pressure coming out of the buffer tank is not sufficient to meet the requirement of the end user. In these cases an auxiliary product compressor is provided to boost the pressure.

The compression of a gas increases its temperature. The simplest relationship between temperature and pressure is linear. The auxiliary product compression in cyclic adsorption processes also requires a recycle stream in order to maintain good control over discharge and suction pressure. The recycle gas stream must be cooled even if the hot product gas is acceptable to the end user. The recycle gas if sent back as hot gas would slowly cause the heat to accumulate in the system and cause entire system to operate hot and fail. Therefore, current industrial practice widely used is to cool the entire gas using an after cooler and recycle a portion of it back to the suction of the compressor.

The present invention provides a method to divert the recycle gas back to the upstream buffer tank in cyclic adsorption processes to allow it to mix with the incoming product gas. The resulting mixture gets cooled using natural convection on the buffer tank walls.

The key advantage of this invention over the prior art is that there is no separate cooler required to cool the recycle gas from the compressor discharge.

### SUMMARY OF THE INVENTION

The present invention provides for a method of connecting the hot recycle gas from the compressor suction discharge of a cyclic adsorption process to the incoming product line, upstream of the buffer tank. This allows for intermixing of cooler product gas and the hotter recycle gas. The resulting mixture further loses heat through natural convection on the wall of the buffer tank. At the compressor suction the resulting steady state temperature is close to the incoming cooler product gas.

### BRIEF DESCRIPTION OF THE DRAWINGS

FIG. 1 presents the method to cool compressor recycle gas using the product buffer tank.

FIG. 2 is a variation of the above method with the buffer tank on a slip stream at the compressor suction.

FIG. 3 is a variation of the above method with the buffer tank on a slip stream at the compressor discharge.

### DETAILED DESCRIPTION OF THE INVENTION

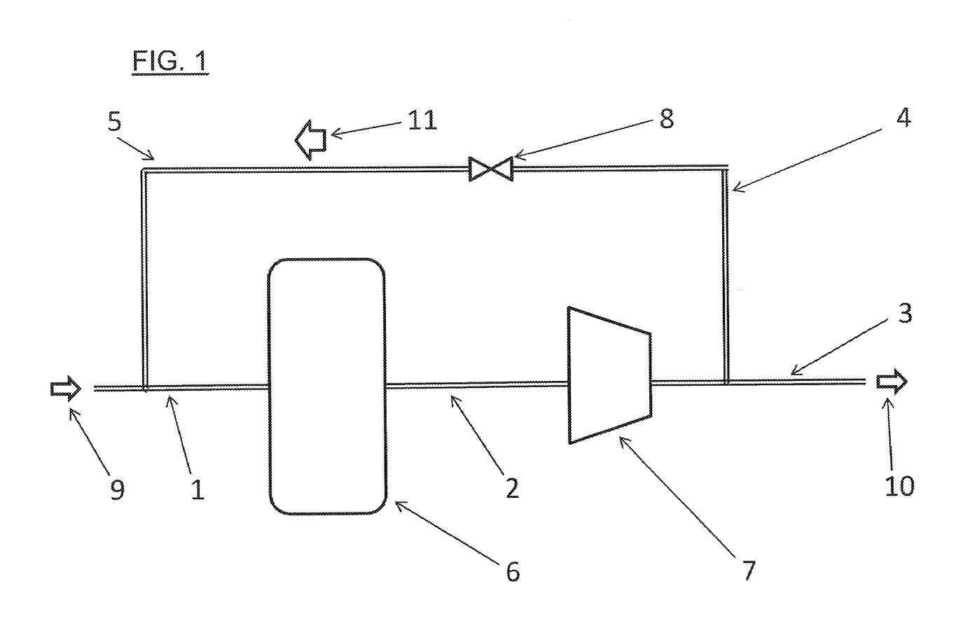

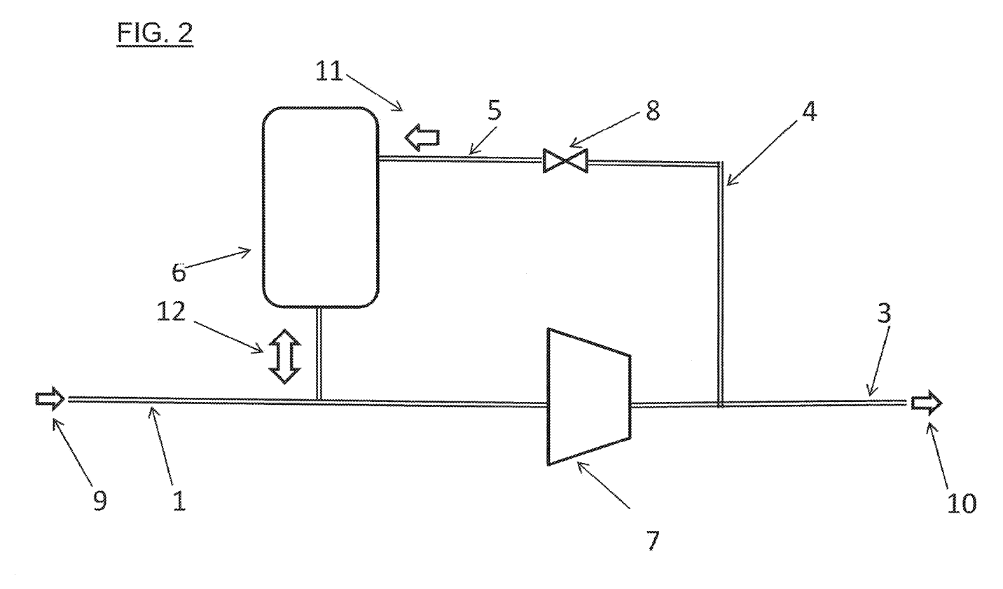

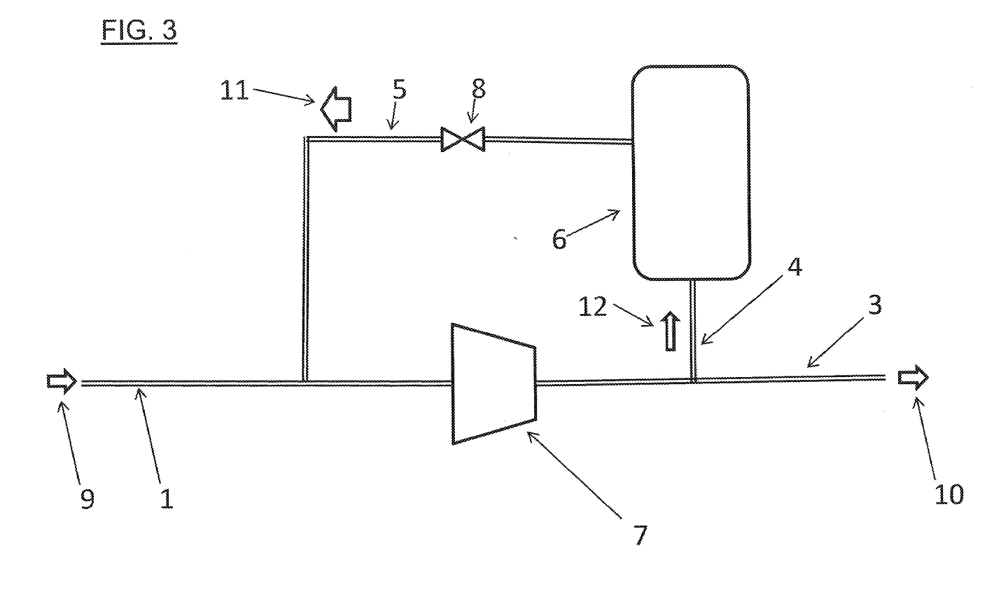

The present invention provides for a method to cool the recycle gas using the upstream buffer tank in cyclic adsorption processes. See FIG. 1 for a schematic sketch of the method. FIGS. 2 and 3 provide variations of FIG. 1 method. Brief description of the schematic is given below.

The product gas (9) from the cyclic adsorption process enters the buffer tank (6) through line 1. The recycle gas (11) joins the product gas through line 5. Together the mixture enters the buffer tank (6). As the mixed gas comes into contact with the buffer tank (6) walls it exchanges heat and in the process gets cooled. The outer walls of the buffer tank (6) exchange heat with the ambient using natural convection. The present inventors have determined that the heat exchange through natural convection from the walls of the buffer tank is substantial and can be used cool a hot gas stream from the compressor discharge. The cooled gas from the Buffer tank (6) passes on the compressor (7) through line 2. A slip stream of recycle gas is taken out from compressor discharge (line 3) and sent back to upstream of the buffer tank (6) through control valve (8). The balance of the hot compressor gas (10) is passed on to the consumer.

A variation of the present invention as shown in FIG. 2 requires the buffer tank (6) to be installed on a slip stream at compressor (7) suction. The hot recycle gas (11) enters the buffer tank (6) directly and mixes with the product. The surplus gas (12) from the product gas (9) from the cyclic adsorption process is fed to the Buffer tank (6) during the producing part of the process. The mixed gas (12) from Buffer tank (6) is fed to the compressor (7) during the non-producing part of the cyclic adsorption process. The hot recycle gas (11) gets cooled inside the buffer tank.

Another variation of the present invention as shown in FIG. 3 requires the buffer tank (6) to be installed on a slip stream at compressor (7) discharge. The discharge gas from compressor (7) is hot and a slip stream (12) to be used as recycle gas is diverted to the buffer tank (6). This stream gets cooled in buffer tank (6) at a higher pressure. The outlet of the buffer tank (6) is fed to the suction of the compressor (7) as recycle gas (11). The cooling accomplished by this method is usually less than the two methods described above.

Having thus described the invention, what we claim are:

1) The recycle gas from a product compressor discharge in cyclic adsorption processes can be cooled by diverting the gas to a buffer tank at the suction of the compressor.

2) The claim 1 method also provides pressure stability at the suction of compressor.

3) The claim 1 method in which the buffer tank is on the slip stream at compressor suction and the recycle gas enters the buffer tank directly.

4) The claim 1 method in which the buffer tank is on the slip stream at the compressor discharge and cools the entire recycle gas before it is sent to compressor suction.
